(19) United States
(12) Patent Application Publication
(10) Pub. No.: US 2005/0267803 A1
(43) Pub. Date: Dec. 1, 2005

(54) Advertising management structure and method for correlating campaigns with consumer interest

(76) Inventors: Arvin Patel, Sunnyvale, CA (US); Saurabh Khetrapal, Palo Alto, CA (US); Raghurami Reddy Etukuru, Plainsboro, NJ (US); Karandeep Sandhu, Mountain View, CA (US)

Correspondence Address: IPSG, P.C., P.O. BOX 700640, SAN JOSE, CA, 95170-0640, US

(21) Appl. No.: 11/021,838

(22) Filed: Dec. 24, 2004

Related U.S. Application Data
(63) Continuation-in-part of application No. 10/853,977, filed on May 25, 2004.

(51) Int. Cl. G06F 17/60

(52) U.S. Cl. 705/14

(57) ABSTRACT

An advertising management structure for determining consumer interest a computer system including a processor, a program, a database and a network communication interface. The database is configured to store records including advertising campaigns and customer records. The program includes a comparison engine configured to access the database and to determine the success of an advertising campaign in a particular market segment. The processor is configured to execute the program and determine consumer interest for a particular campaign. In one aspect, the processor is configured to suggest improvements to the advertising campaign and future campaigns can incorporate the suggestions. In another aspect, the processor is configured to determine a return on investment for the campaign. Advantages of the invention include the ability to collect information regarding advertising campaigns and to use that information to develop a return on investment.

### RELATED APPLICATIONS

This is a continuation in part of Ser. No. 10/853,977 filed May 25, 2004, incorporated herein by reference.

### FIELD

The invention relates to the general field of an advertising management structure and method for correlating campaigns with consumer interest. In particular, the invention employs a computer structure that incorporates an advertising management structure and method for determining consumer response, interest and sales.

### BACKGROUND

Advertising management is important for a business to understand which of its advertising dollars are creating consumer interest, sales and a return on investment. Conventional techniques for determining advertising return include test marketing in certain areas and/or to certain customer categories, coupon codes, and so forth.

The general problem is how to develop a comprehensive media campaign that maximizes a company's sales and profits. When companies spend marketing dollars advertising via radio, TV, print, internet, referrals or affiliates it is very difficult for them to get accurate and real time return on consumer interest statistics. This is especially true for what is called direct response marketing. Often multiple marketing campaigns are running via multiple channels and it is nearly impossible for a company to accurately track individual performance of each campaign, in real-time or otherwise.

Often it is long after a marketing campaign that the company gets to calculate the effectiveness of the campaign. At this stage the advertising money has already been expended. Some of the challenges for companies and media companies in any marketing campaign include a number of aspects in identifying and tracking a correlating advertising with sales.

There is a strong desire to collect, track and maintain important information relevant to each campaign. For example, business and media companies want to know the effectiveness of the marketing campaign. By knowing what is working and what is not, ideally in real-time or as soon as possible, the marketing budget can be allocated appropriately. When multiple campaigns are running simultaneously, there is a desire to know the individual contribution from each campaign. The businesses can then allocate their budget across their portfolio and across various marketing campaigns in target markets. The business can determined which campaigns should be rerun and which should be scrapped. These and more concerns persist in the marketplace.

What is needed is an improved advertising management structure and method for determining return on investment.

### SUMMARY

The invention is designed to overcome a number of known limitations in advertising management and information gathering to correlate advertising campaigns with consumer interest and sales. In one aspect, the interest and sales are used to determine return on investment (ROI). The invention is particularly useful when a company is engaged in multiple simultaneous advertising campaigns.

An exemplary embodiment of the advertising management structure for determining consumer interest comprises a computer system including a processor, a program, a database and a network communication interface. The database is configured to store records including advertising campaigns and customer records. The program includes a comparison engine configured to access the database and to determine the success of an advertising campaign in a particular market segment. The processor is configured to execute the program and determine a return on investment for a particular campaign.

In one aspect, the processor is configured to suggest improvements to the advertising campaign and future campaigns can incorporate the suggestions.

In another aspect, the processor is configured to determine a return on investment for the campaign.

Advantages of the invention include the ability to collect information regarding advertising campaigns and to use that information to improve customer interest and develop a higher return on investment. The invention provides visibility to companies so that they can improve their advertising campaigns to be more effective to a target audience.

### DRAWINGS

The invention is described with reference to the following figures:

FIG. 1A depicts a server including a processor, database and network interface according to an embodiment of the invention;

FIG. 1B depicts a server of FIG. 1A in a network environment communicating with client computers and databases according to an embodiment of the invention;

FIGS. 2A-C depict database structures and information according to an embodiment of the invention; and

FIGS. 3A-D are flowcharts showing methods of operation according to embodiments of the invention.

### DETAILED DESCRIPTION

The invention is designed to overcome a number of known limitations in advertising management and information gathering to determine consumer interest. The invention is particularly useful when a company is engaged in multiple simultaneous advertising campaigns.

While the invention is described with reference to specific apparatus and embodiments. Those skilled in the art will recognize that the description is for illustration and to provide the best mode of practicing the invention. Those skilled in the art will also recognize that variations and modifications can be made to the invention while remaining within the spirit of the claims. For example, while reference is made to a server including a database, the database can also reside on a different server and be accessed over a network. Also, while the preferred network is the Internet, any communication network can be used in the invention.

There are a number of persistent challenges for businesses and media companies in marketing campaigns, including the following.

(a) The client business and media company want to know the effectiveness of the marketing campaign. The business wants to know what is working and what is not, ideally in real-time or as soon as possible, so that marketing budget can be allocated appropriately.

(b) When multiple campaigns are running simultaneously, the business people want to know the individual contribution from each campaign. This information is useful in deciding how to allocate the budget across the portfolio and across various marketing campaigns.

(c) The business people want to know how to staff to handle sales.

(d) When customers call, they may hang up before telling the agent how they heard about the promotion or service being advertised. The business people want to know how to improve the capture of media information resulting in more accurate media ROI numbers.

(e) Most companies do not have sophisticated and advanced telecommunication hardware and software to capture the number of incoming calls for the specific service or promotion advertised.

(f) When multiple media sources are used in a marketing campaign, the business people want to know the individual contribution from each media source.

(g) The business people want to know how many sales, what is the ROI daily or in any time interval (real-time) for each media source and/or marketing campaign.

(h) The business people want to know if the media station did indeed run the promised number of spots/day.

These any other challenges are addressed in-whole or in-part by the invention and various embodiments and aspects thereof.

A. Architecture

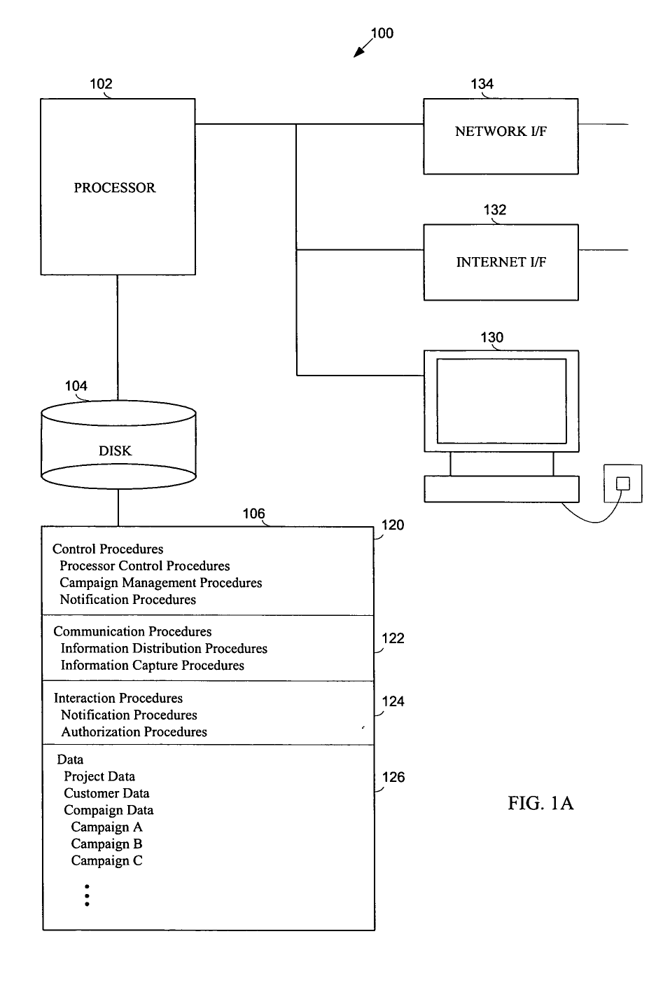

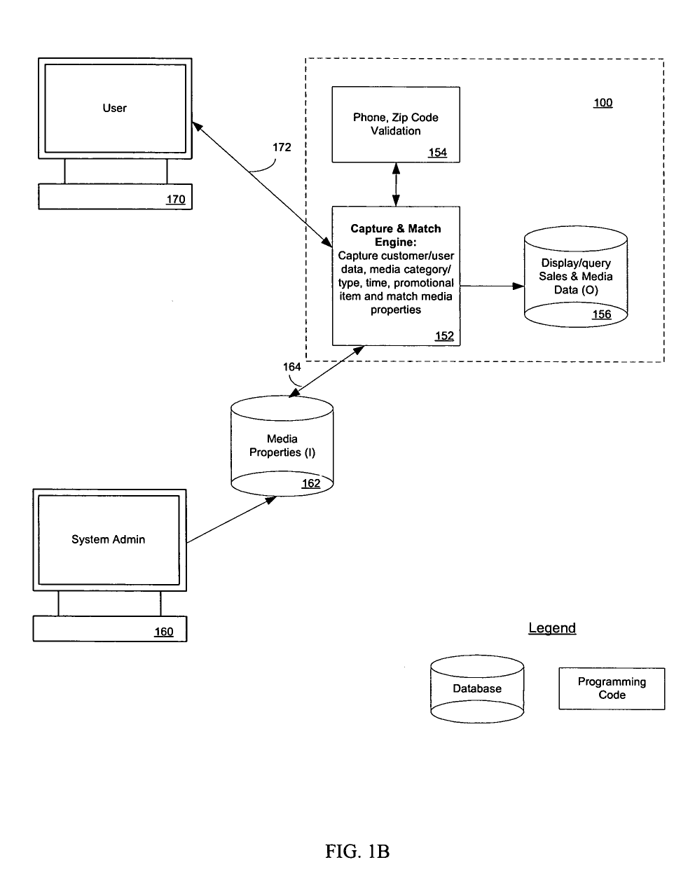

FIG. 1A depicts an exemplary computer system 100 to aid in performing advertising management according to embodiments of the invention. The exemplary computer system includes a processor 102 and a storage device 104, for example, a disk drive. The storage device stores information 106 including control procedures and data for carrying out the invention. The server 100 further includes interfaces 132, 134 to communication with other networks and a user interface 130.

The invention helps advertisers track and correlate their marketing and/or advertising campaigns to consumer interest. The invention captures and displays each individual marketing lead in real-time (function of time) and segments it via its media category/type and end result (sale or no sale), enabling a company to accurately see consumer interest and sales in real-time. It thereby determines the advertising schedule that will result in the optimum short and long term advertising-driven volume for any brand or product. In one aspect, the invention employs the data to calculate a return on investment (ROI).

FIG. 1B depicts server 100 in a network environment communicating with client computers and databases according to an embodiment of the invention. This is the logical architecture of the invention demonstrating the information that is accessed and collected in the invention. This architecture and process is described in more detail with reference to the database structures and flowcharts below.

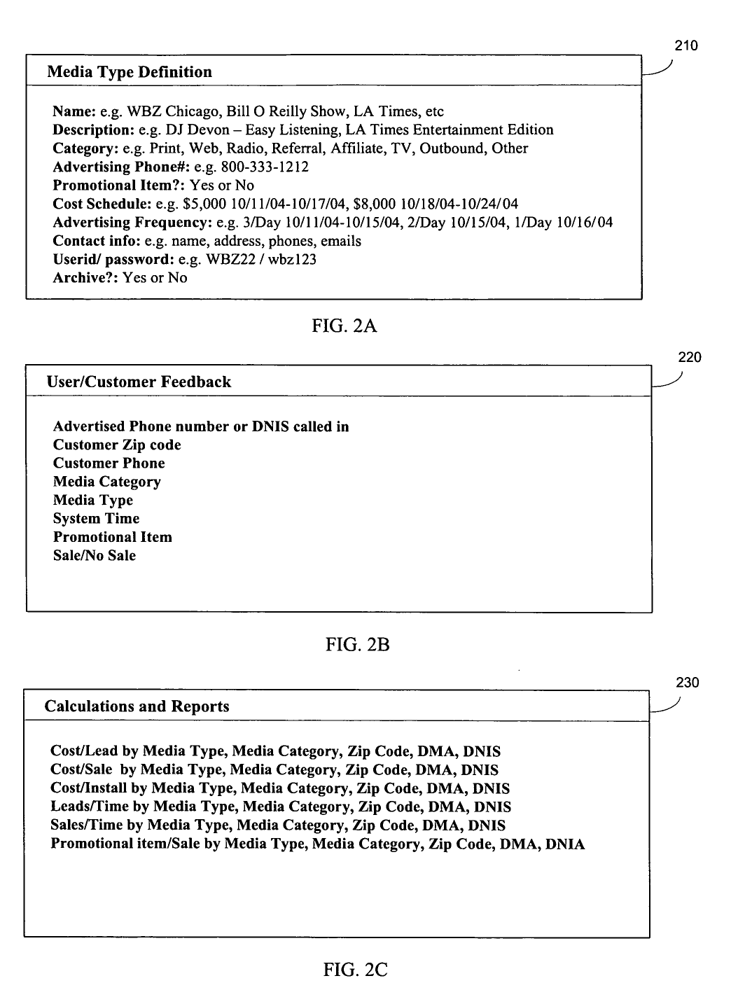

FIGS. 2A-C depict database structures and information according to an embodiment of the invention. FIG. 2A depicts a table 210 with media type definitions for each of the campaign outlets, of which only one record is shown. The table comprises many records of this type for identifying parameters of the media outlets. This information is important because it identifies the outlets for the marketing campaign and supports the association of customer interest with the media outlet. FIG. 2B depicts a table 220 with customer feedback including a number of details regarding each potential customer, product or service of interest, media category, media type, geographic location and so forth. Detailed demographic information can be associated with the potential customers from information gathered directly from the customers, or from other databases of customer information. FIG. 2C depicts a table 230 with calculations and reports that are generated for the marketing campaigns to determine customer interest and other qualitative and quantitative data. In one aspect, the qualitative and quantitative data includes return on investment (ROI).

The invention collects information and provides data regarding a number of key factors including: (a) advertising responsiveness by product and market; (b) seasonal sales patterns; (c) daily, weekly or monthly variation in media costs; (d) advertising saturation/decay rates; (e) daily, weekly or monthly variation in demand as a function of time, which also enables one to track advertising spots played by the media company. The invention also provides graphical or tabular reports show marketing ROI metrics in a number of formats to including information such as—by campaign, program type, owner, date, channel, product line, audience, market, media category or type or keywords.

B. Advertising Data Management

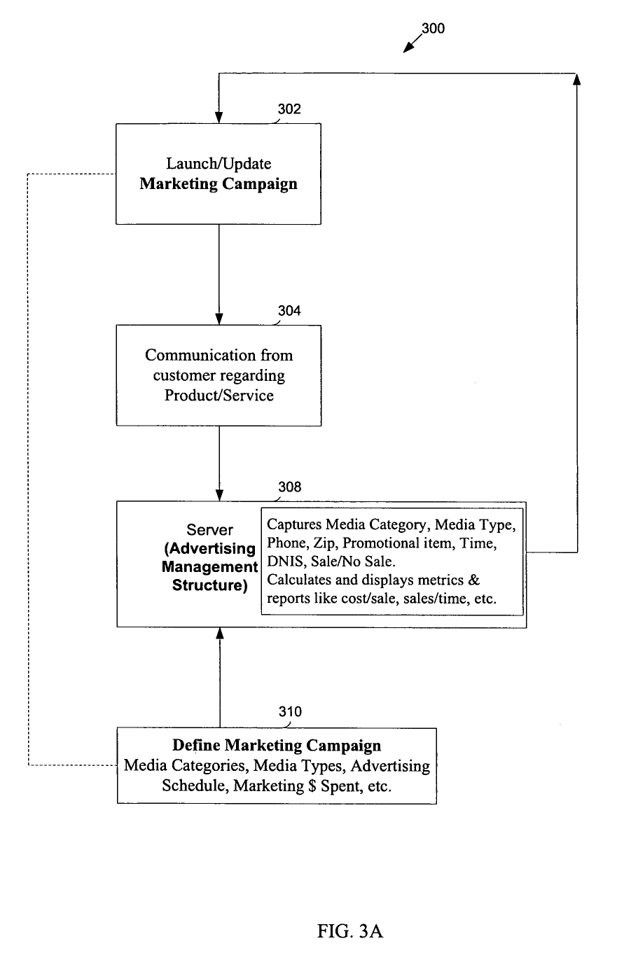

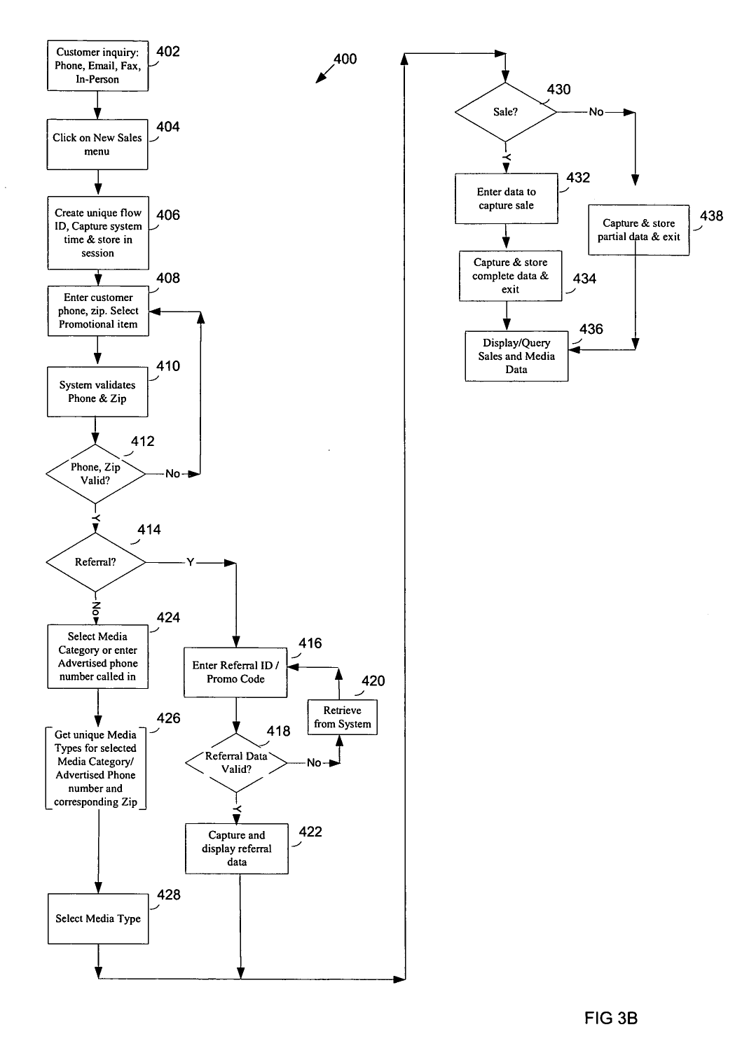

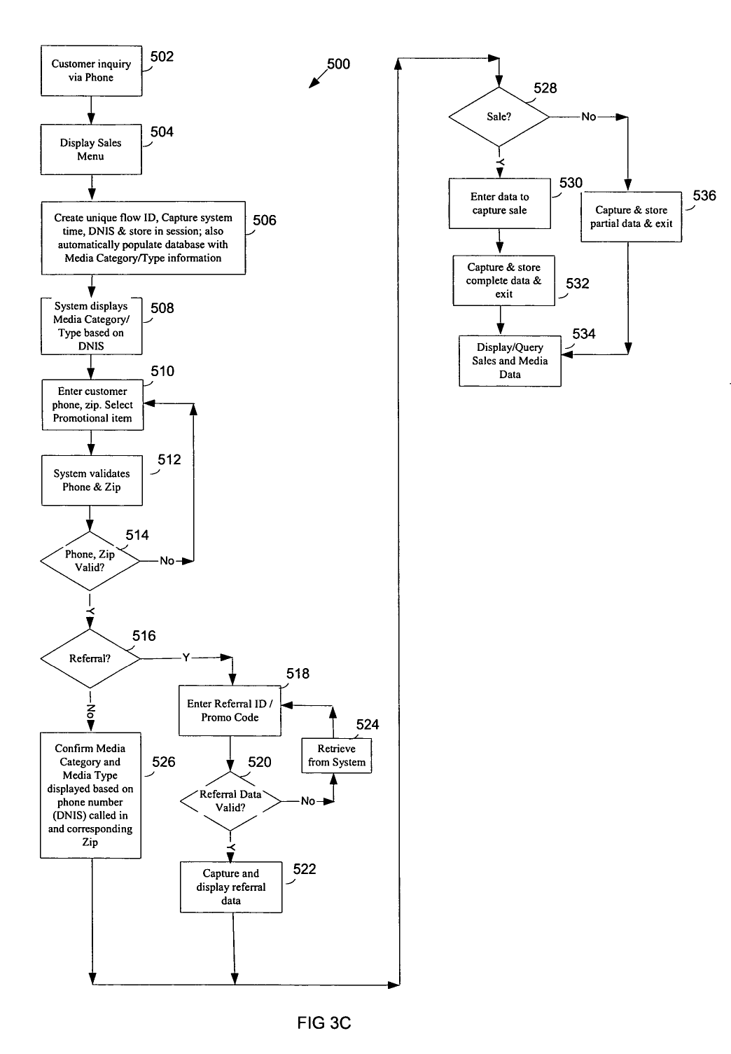

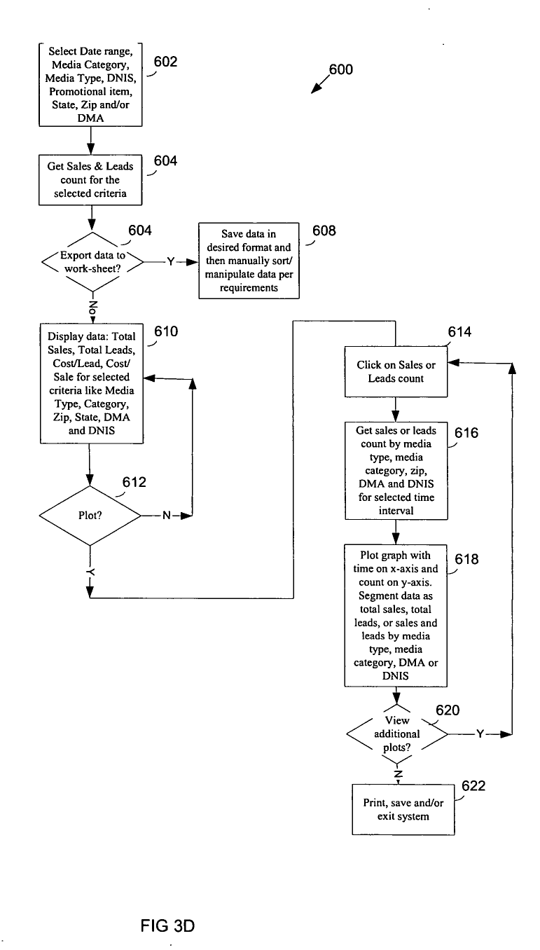

The invention supports the following operations regarding data entry and management. This data is stored in one of more databases accessible to the server 100. The invention includes the following features that support the campaign management process. FIGS. 3A-D are flowcharts showing methods of operation according to embodiments of the invention.

1. Overview

FIG. 3A is a flowchart 300 showing an overview of an exemplary embodiment. A marketing campaign is typically designed and launched based on various demographic and strategic metrics, like household income, population size, ethnicity, competitor activity, time to market of the product, etc. If the marketing campaign is being repeated, then one relies more on the past performance metrics of the campaign. Unfortunately very little data is typically available to marketing teams from past campaigns to make an informed decision.

Now once the promotion and geographic location or DMA is finalized, the marketing channel or media category is identified, e.g. radio, print, TV, web, etc. Typically a promotional item, like a DVD player or Digital Camera, is tagged to the promotion to generate the call volume. The first step in preparing the system, which is represented at step 310, is to enter all of the marketing campaign information to populate the data table shown in FIG. 2A.

Once all of the marketing campaign information is entered into the system, step 302 is performed to officially launch the marketing campaign. Step 304 involves marketing campaign getting the targeted customer to call the phone number advertised. A sales agent engages the prospective customer by answering questions and also by obtaining information from the customer to populate the data table shown in FIG. 2B with relevant customer information. Step 306 takes the captured customer data, associates the data with a marketing campaign and can display metrics and reports associated therewith. At any time in the campaign, users can access the information in the database to get a snap shot of the performance of the campaign. Based on the data presented, e.g. referring to FIG. 2C, a decision can be made to continue, modify or abandon the marketing campaign. This data is stored in the system and can be accessed at any time by users with appropriate privileges. If changes are made to the campaign, the user updates the media campaign data appropriately (e.g. update money spent, number of spots played, etc) and the campaign continues.

The system provides the ability to users, in real time or otherwise, to interact with the marketing campaign to ensure that the desired metrics are met and ensure a high ROI for the marketing campaign.

In the exemplary embodiment, the user has the ability to enter and manage data, and create the various media types in the application. For example, in radio advertising, assign DJs and radio station names and daily adverting schedule. Tie in any special marketing attributes, if applicable, to each media source like promotional items allowed, dialed number identification service (DNIS) or phone number to be used, daily costs, daily spots, etc. Give each media company user ID/passwords such that they can login to access the data from the invention via the web.

2. Flowchart Operation

FIG. 3B is a flowchart 400 showing an exemplary embodiment. This method provides a capture and match by manual selection of media category and type. Step 402 involves obtaining data from prospective customers. In the exemplary embodiment, the user has the ability to capture and match the data. In steps 402-404, when a customer contacts the company's point of sale office, the sales agent clicks on a menu that can either recall information for an existing customer, or enter information for a new prospective customer. Step 406 captures the system time and session for the sales agent workflow with the customer. In steps 406-412, the sales agent interacts with the prospective customer to obtain data from the customer, for example, the customer's address, telephone number and zip code, and then confirms the validity of the customer's information. In steps 414-428, the sales agent determines whether the customer is a referral and works to associate the customer with either a referral ID, or a media category and type. A referral ID would match one stored in the system and would identify the media category and type. In one aspect, if the customer doesn't have a referral ID, the agent obtains the telephone number that the customer called into and the system automatically determines the media source and media type to associate with the customer. Steps 430-436 involve the sales process to convince the customer to purchase the product and/or service. Either way, the system records the sale or no-sale and matches it to the media category and type, along with other information, e.g., the time and date of the inquiry. All the data is recorded, updated and accessible real-time by multiple users.

FIG. 3C is a flowchart 500 showing an exemplary embodiment. This method provides a capture and match with technology built into the system for automatically obtaining the media category and type. Step 502 involves obtaining data from prospective customers. In the exemplary embodiment, the user has the ability to capture and match the data. In steps 502-504, when a customer contacts the company's point of sale office, the sales agent clicks on a menu that can either recall information for an existing customer, or enter information for a new prospective customer. Step 506 captures the system time and session for the sales agent workflow with the customer, which is similar to step 406. Step 506 further includes the step of obtaining additional information about the customer called a customer attribute, for example, from a dialed number identification service (DNIS) lookup or telephone number reverse lookup, e.g. caller ID. This marketing manager assigns each media outlet a phone number to use for the marketing campaign. The, for example, when a customer calls in one telephone number 555-1111, the invention associates the customer with a first media source having a Media Category/Type, while if the customer calls in on telephone number 555-2222, the invention associates the customer with a second media source having a Media Category/Type and so on. Step 506 can also automatically populate database with information such as Media Category/Type, geography, and other information based on one or more caller attributes. This is particularly helpful since many existing sales agents may not accurately identify the information due to human error or oversight. Further, the invention decreases the time the sales agent spends in collecting data which increases the productivity of the sales agent while lowering the cost associated with time billable agents. Hence, this automated process step improves the accuracy and efficiency of the telephone use and permits improved evaluation of the data. The improved accuracy also helps with cross-selling opportunities that may be targeted to customers having particular attributes. For example, a person with a Media Category/Type associated with a first demographic may live in a cold climate and have the need for an appliance for removing snow or the like, while a person associated with a second demographic may live in a sunny climate and be a potential customer for sunscreen or air-conditioning maintenance services. Many more examples of potential cross-selling opportunities based on such attributes and demographic information are anticipated.

Step 508 display the media category and type based on the customer attribute. In steps 510-514, the sales agent interacts with the prospective customer to obtain data from the customer, for example, the customer's address, telephone number and zip code, and then confirms the validity of the customer's information. In steps 516-526, the sales agent determines whether the customer is a referral and works to associate the customer with either a referral ID, or a media category and type. A referral ID would match one stored in the system and would identify the media category and type. Steps 528-536 involve the sales process to convince the customer to purchase the product and/or service. Either way, the system records the sale or no-sale and matches it to the media category and type, along with other information, e.g., the time and date of the inquiry. All the data is recorded, updated and accessible real-time by multiple users.

While the methods described above with reference to flowcharts 400 and 500 are described with reference to telephone sales, the methods are equally applicable to internet sales or other types of sales channels.

FIG. 3D is a flowchart 600 showing an exemplary embodiment. This method provides a query and display of the data. Step 602 selects the search parameters, for example, date range, media category, media type and so forth. Step 604 retrieves the information based on the query, and step 604 experts the data to a display format.

Based on the information provided, the user can track real-time marketing ROI for each media stations. For example, for Radio Station, WBZ in Chicago, the system records M sales clicks and N sales. Therefore, based on the marketing dollars spent, the user can get the cost/lead and cost/sale for the media type WBZ Chicago. Also, WBZ radio can log-in via the internet to track the sales data in real time. A user can also track the ROI for a media category by tracking the calls made to the specific dialed number identification service (DNIS) and the corresponding sales registered in the system.

Additionally the M calls can be plotted as a function of time, say in intervals of ½ hr and the resulting plot can give an idea of how many radio spots were played and can be compared with the agreed upon contract. For example, if there are three peaks, in call volume, then it can be inferred that three spots were played. If, for example, the advertisement contract called for five commercials and only three peaks are identified, the advertiser can infer that the radio station did not plan two of the five spots. Alternately, the advertiser can infer that advertising during those periods of time where no spikes are seen is not providing an ROI. . This data is also used to staff the sales center appropriately as it identifies demand peaks over the day.

C. Desirable Features

The invention also includes a number of desirable features set forth in Table 1 below.

TABLE 1

| | |
|---|---|
| Marketing ROI | Bring quantitative proof to the table. |
| Reporting | ROI Reports by media campaign, |
| | program, and program type to show |
| | you what paid off. View Cost/Lead |
| | and Cost/Sale reports based on Media |
| | Type, Media Category, Zip Code, |
| | DMA, and DNIS number. |
| Graphical and | Easy to read and understand, graphical |
| Tabular Reports | and tabular reports. View Cost/Lead, |
| | Cost/Sale, Leads/Time, Sales/Time |
| | reports based on Media Type, Media |
| | Category, Zip Code, DMA and DNIS number. |
| Metrics Report | Report shows leads, inquiries, sales, |
| | and revenue by month and campaign. |
| | Can also help to track ‘spots’ |
| | and also to staff appropriately. |
| Web Based | Deploy instantly with Web-based |
| | Application Service Provider (ASP) |
| | model. (note: it can be integrated |
| | as a stand alone application to customer's |
| | existing enterprise applications). |
| Excel Export | Perform unlimited analysis and |
| | reporting by exporting data to Excel. |

D. Conclusion

Advantages of the invention include the ability to collect information regarding advertising campaigns and to use that information to develop a return on investment. The invention provides visibility to companies so that they can improve their advertising campaigns to be more effective to a target audience.

Having disclosed exemplary embodiments and the best mode, modifications and variations may be made to the disclosed embodiments while remaining within the subject and spirit of the invention as defined by the following claims.

1. A marketing management structure for determining consumer interest, comprising:
a computer system including a processor, a program, a database and a network communication interface;
wherein the database is configured to store records including advertising campaigns and customer records;
wherein the program includes a comparison engine configured to access the database and to determine the success of an advertising campaign in a particular market segment; and
wherein the processor is configured to execute the program and determine consumer interest for a particular campaign.

2. The marketing management structure of claim 1, wherein:
the database is configured to store media categories and types associated with each advertising campaign; and
the processor is configured to associate customer inquiries with the media categories and types.

3. The marketing management structure of claim 2, wherein:
the database is configured to store customer inquiry data and associate the inquiry data with media categories and types associated with each inquiry.

4. The marketing management structure of claim 3, wherein:
the database is configured to store customer purchase data associated with the customer inquiry data.

5. The marketing management structure of claim 3, wherein:
the processor is configured to report associations of customer inquiries with customer purchase data for the media categories and types.

6. The marketing management structure of claim 4, wherein:
the processor is configured to report associations of customer inquiry data with customer purchase data for the media categories and types.

7. The marketing management structure of claim 2, wherein:
the processor is configured to automatically populate data fields associated with the media categories and types based on the customer inquiry.

8. The marketing management structure of claim 3, wherein:
the processor is configured to automatically populate data fields associated with the media categories and types based on the customer inquiry.

9. The marketing management structure of claim 4, wherein:
the processor is configured to provide information for improving a marketing campaign.

10. The marketing management structure of claim 5, wherein:
the processor is configured to provide information for improving a marketing campaign.

11. The marketing management structure of claim 6, wherein:
the processor is configured to provide information for improving a marketing campaign.

12. The marketing management structure of claim 7, wherein:
the processor is configured to provide information for improving a marketing campaign.

13. A method of managing a marketing campaign to determine consumer interest using a computer system including a processor, a program, a database and a network communication interface, comprising the steps of:
storing records including advertising campaigns and customer records in the database;
accessing the database to determine the success of an advertising campaign in a particular market segment; and
executing the program and determine consumer interest for a particular campaign.

14. The method of claim 13, wherein:
the storing step includes the step of storing media categories and types associated with each advertising campaign; and
the method further comprises the step of associating customer inquiries with the media categories and types.

15. The method of claim 14, wherein:
the storing step includes the step of storing customer inquiry data and associating the inquiry data with media categories and types associate with each inquiry.

16. The method of claim 15, further comprising the step of:
storing associations of customer inquiries with customer purchase data for the media categories and types.

17. The method of claim 15, further comprising the step of:
storing associations of customer inquiry data with customer purchase data for the media categories and types.

18. The method of claim 14, further comprising the step of:
automatically populating data fields associated with the media categories and types based on the customer inquiry.

19. The method of claim 15, further comprising the step of:
automatically populating data fields associated with the media categories and types based on the customer inquiry.

20. The method of claim 16, wherein:
the executing step includes the step of providing information for improving a marketing campaign.

21. The method of claim 17, wherein:
the executing step includes the step of providing information for improving a marketing campaign.

22. The method of claim 18, wherein:
the executing step includes the step of providing information for improving a marketing campaign.
